(19) United States
(12) Patent Application Publication
(10) Pub. No.: US 2024/0212900 A1
(43) Pub. Date: Jun. 27, 2024

(54) ELECTRICAL STEEL SHEET COMPOSED OF (001) TEXTURE, AND MANUFACTURING METHOD THEREFOR

(71) Applicant: THERMVAC INC., Hwaseong-si, Gyeonggi-do (KR)

(72) Inventors: Nam Hoe HEO, Hwaseong-si (KR); In Seok CHOI, Seoul (KR)

(73) Assignee: THERMVAC INC., Hwaseong-si, Gyeonggi-do (KR)

(21) Appl. No.: 18/288,690

(22) PCT Filed: Oct. 5, 2021
(86) PCT No.: PCT/KR2021/013584

§ 371 Date: Oct. 27, 2023

(30) Foreign Application Priority Data
May 3, 2021 (KR) 10-2021-0057167

(51) Int. Cl. H01F 1/147; C21D 1/74; C21D 6/00; C21D 8/12; C21D 9/46; C22C 38/00; C22C 38/02; C22C 38/04

(52) U.S. Cl. CPC H01F 1/14783; C21D 1/74; C21D 6/005; C21D 6/008; C21D 8/1222; C21D 8/1233; C21D 8/1261; C21D 8/1266; C21D 8/1277; C21D 9/46; C22C 38/001; C22C 38/002; C22C 38/004; C22C 38/02; C22C 38/04; C22C 2202/02

(57) ABSTRACT

An electrical steel sheet according to the present disclosure contains, based on weight, Si of 2.0% to 4.0%, Mn of more than 0.5% and 2.0% or less, S of 0.01% or less (excluding 0%), C of 0.01% or less (excluding 0%), N of 0.01% or less (excluding 0%), and the balance composed of Fe and unavoidable impurities. The iron steel sheet is composed of (001) crystal grains, has a thickness of 0.05 to 0.25 mm after two-stage cold rolling, and an angle (θ) of 0°≤θ≤8° between a rolling direction and [100] crystal orientation exhibiting a maximum surface intensity in (001) texture.

### TECHNICAL FIELD

The present disclosure relates to an electrical steel sheet composed of (001) texture and a manufacturing method therefor.

### BACKGROUND ART

Electrical steel sheets play an important role in determining the energy efficiency of electrical devices. This is because electrical steel sheets are used for iron cores of rotating equipment such as motors and generators and stationary equipment such as small transformers and convert electrical energy into mechanical energy.

Magnetic properties of electrical steel sheets include iron loss (W_{15/50/kg} or W_{10/400/kg}) and magnetic flux density (B₈ or B₅₀). The lower the iron loss, the better the quality of iron steel because the iron loss means energy loss. On the other hand, the value of the magnetic flux density indicates the ease of magnetization upon application of an external magnetic field. As the value of the magnetic flux density increases, the desired magnetic flux density can be obtained by application of a smaller current, and the copper loss occurring in copper windings decreases. Therefore, the higher the magnetic flux density, the better.

In general, among the magnetic properties of electrical steel sheets, iron loss can be reduced by adding alloying elements with high resistivity, such as Si, Al, and Mn. However, although iron loss can be reduced by adding these alloying elements, a decrease in magnetic flux density is unavoidable. Furthermore, as the amount of silicon (Si) and aluminum (Al) added increases, cold rolling becomes difficult, resulting in productivity decrease. In this case, an increase in hardness occurs, resulting in plate breakage, which means poor processability.

Currently, for non-oriented electrical steel sheets used for iron cores of commercial motors, iron losses are reduced to maximize resistivity by adding a large amount of Si, Al, Mn, etc., or eddy current loss, which is one type of iron loss among eddy current loss and hysteresis loss, is reduced by thinning steel sheets.

However, most of these non-oriented electrical steel sheets have poor magnetic properties because they have {111}<uvw> texture, and the area fraction of the (001) plane having the [100] crystalline axis, which is an easy axis for magnetization, is about 5 to 10%. For example, in the case of a 0.35 mm-thick steel sheet, as the content of Si and Al in the steel sheet decreases, the magnetic flux density (B₅₀) advantageously increases up to about 1.65 to 1.71 Tesla, but the iron loss (W_{15/50}) disadvantageously increases from about 2 W/kg to about 3 W/kg. In the case of a 0.50 mm-thick steel sheet, the content of Si and Al decreases, the magnetic flux density (B₅₀) advantageously increases up to about 1.67 to 1.70 Tesla, but the iron loss (W_{15/50}) unavoidably increases to about 2.4 to 3.55 W/kg. In other words, since the conventional production process for non-oriented electrical steel sheets cannot increase the area fraction of (001) grains with good magnetic properties to more than about 5%-10%, the manufacturers are pursuing iron loss reduction by adding a large amount of Si, Al, Mn, etc. that increase resistivity.

For dramatic increase in motor performance, it is necessary to dramatically increase the area fraction of (001) grains having the [100] orientation, which is the axis for easy magnetization, and to dramatically reduce the area fraction of {111} grains that impair the magnetic properties, in electric steel sheets.

Methods of increasing the area fraction of (001) grains are disclosed in U.S. Patent Application Publication No. US005948180A, European Patent Publication No. EP 0 741 191 B1, and Academic Literatures 1 and 2. In these references, cold-rolled steel sheets made from hot-rolled steel sheets containing 0.05% to 0.1% of carbon (C), which is an austenite (γ) stabilizing element, is heat treated at a ferrite (α)+austenite (γ) two-phase temperature in the range of 950° C. to 1050° C., in a high vacuum atmosphere to grow (001) grains using a phase transformation from austenite (γ) to ferrite (α) resulting from a decarburization reaction.

In the disclosures disclosed in the literatures, during the heat treatment at the relatively low temperatures of 950° C. to 1050° C. and the high vacuum level, Mn evaporates from the surface as soon as the decarburization reaction starts, and surface oxidation occurs due to the relatively low temperature range even at the high vacuum level, thereby showing a gradual decrease in manganese content from the deep inside to the surface of the steel sheet. Therefore, the formation of a surface demanganese layer and a surface oxide film that are detrimental to magnetic properties cannot be avoided.

In the disclosures disclosed in the literatures, the temperature for the phase transformation from austenite (γ) to ferrite (α) through a high vacuum decarburization reaction to promote the growth of (001) grains is limited to the relatively low temperature range of 950° C. to 1050° C., resulting in a low (001) area fraction of 65% or less (European Patent Publication No. EP 0 741 191 B₁).

In addition, as can be seen from Academic Literatures 1 and 2, the cross-sectional structure of the steel sheet obtained through the disclosures mentioned above is characterized by a shape in which (001) ferrite (α) crystal grains grow from the surfaces of a steel sheet toward the inside of the steel sheet, i.e., in the direction of decarburization from the surfaces of the steel sheet to the inside of the steel sheet during heat treatment. Therefore, the grain growth finally meets at the center of the steel sheet.

Meanwhile, Korean Patent Application Publication Nos. 10-0797895 and 10-0973406 propose methods of manufacturing electrical steel sheets composed of (001) texture, but these disclosures also involve phase transformation from austenite (γ) to ferrite (α) to grow (001) grains.

The (001)-texture electrical steel manufacturing methods of the disclosures disclosed in the literatures failed to be commercialized due to the complicated heat treatment process involving vacuum heat treatment and the low area fraction of (001) grains obtained after final annealing.

In addition, Korean Patent Application Publication No. 10-1842417 discloses a method of manufacturing an electrical steel sheet composed of (001) texture through typical cold rolling and heat treatment processes. However, in this disclosure, the content of Mn, which has a large iron loss reduction effect, is limited to a maximum of 0.5%.

When the content of Mn is less than 0.5% as in the above-mentioned disclosures, during the hot rolling and cooling process, the annealing of the hot rolled steel sheets, or the final annealing of the cold rolled steel sheets, the amount of precipitation of MnS is small and thus a large amount of atomic sulfur (S) remains in a base phase.

As will be described in detail in the following disclosure section, this large amount of atomic sulfur is concentrated in a surface layer of the steel sheet during final annealing, resulting in the surface energy of the {111} crystal surface being lower than the surface energy of the (001) crystal surface, thereby promoting the growth of {111} grains rather than the growth of (001) grains during the final annealing. Therefore, the final annealing is likely to yield an electrical steel sheet composed of {111} grains is likely to be produced rather than an electrical steel sheet composed of (001) grains, and this phenomenon becomes more dominant as the thickness of the steel sheet increases. Therefore, for a steel sheet having a given sulfur concentration, the key technology for efficiently manufacturing an electrical steel sheet composed of (001) grains is to activate the MnS precipitation reaction and to minimize the amount of sulfur employed in the steel sheet by addition of a large amount of Mn. The addition of Mn controls the surface energy of the (001) crystal surface to be minimized during the final annealing, to create conditions in which (001) grains can easily grow and encroach on {111} or {110} grains, thereby producing electrical steel sheets composed of (001) grains.

Therefore, to solve these various problems occurring in the related art, the present disclosure suggests a method of manufacturing an electrical steel sheet exhibiting a relatively high area fraction of (001) grains, a relatively high magnetic flux density, and a significantly reduced iron loss compared to the conventional technologies described above. To this end, Mn is added in an amount of 0.5% to 2.0% to form a ferrite (α) single phase or a ferrite (α)+MnS precipitate mixed phase in which ferrite (α) and MnS precipitates are mixed, with no austenitic (γ) phase in the whole heat treatment temperature range; and final annealing is performed in a 1-atm reducing atmosphere and a temperature range in which no austenite (γ) phase exists and a ferrite (α) single phase or a ferrite (α)+MnS precipitate mixed phase in which ferrite (α) and MnS precipitates are mixed exists, so that a decomposition reaction of excessive MnS precipitates generated due to the addition of an excessive amount of Mn for iron loss reduction is activated, and the growth of (001) grains is accelerated.

### DISCLOSURE

### Technical Problem

To solve these various problems occurring in the related art, the present disclosure provides a method of manufacturing an electrical steel sheet composed of (110 texture that does not exhibit deterioration in magnetic properties, which can be caused by the formation of a surface demanganese layer and a surface oxide layer, has an average (110) grain diameter that passes through the steel sheet in a thickness direction and which is 10 to 15 times larger than the thickness of the steel sheet, exhibits a significantly reduced iron loss due to the addition of a large amount of manganese (Mn), and exhibits a high magnetic flux density due to a high area fraction of a highly integrated (001) grains. For the formation of (001) texture, the method does not use phase transformation from austenitic (γ) to ferrite (α) through demanganese and decarburization reactions in a high vacuum-level decarburization atmosphere as described in U.S. Patent Application Publication No. US005948180A, European Patent Publication No. EP 0 741 191 B1, and Academic literatures 1 and 2 but uses the following process: Mn is added in an amount of 0.5% to 2.0% to form a ferrite (α) single phase or a ferrite (α)+MnS precipitate mixed phase in which ferrite (α) and MnS precipitates are mixed while having no austenitic (γ) phase in the whole heat temperature range, and final annealing is performed in a 1-atm reducing atmosphere and a relatively high temperature range in which no austenite (γ) phase exists and a ferrite (α) single phase or a ferrite (α)+MnS precipitate mixed phase in which ferrite (α) and MnS precipitates are mixed exists, so that a decomposition reaction of excessive MnS precipitates generated due to the addition of an excessive amount of Mn for iron loss reduction is activated, and the growth of (001) grains is accelerated.

Meanwhile, other unspecified purposes of the present disclosure may be additionally considered within the scope that can be easily inferred from the following detailed description and its effects.

### Technical Solution

To achieve this purpose, one embodiment of the present disclosure provides an electrical steel sheet containing Si in a content of 2.0% to 4.0%, Mn in a content of more than 0.5% and 2.0% or less, S in a content of 0.01% or less (excluding 0%), C in a content of 0.01% or less (excluding 0%), N in a content of 0.01% or less (excluding 0%), and the residual including Fe and unavoidable impurities, in which the steel sheet is composed of (001) crystal grains and has a thickness of 0.05 to 0.25 mm after two-stage cold rolling, in which an angle (θ) between a rolling direction and a [100] crystal orientation in a (001) texture exhibiting a maximum face strength satisfies a condition of 0°≤θ≤8°.

The electrical steel sheet according to an example of the present disclosure may have an average (001) grain diameter larger than the thickness thereof, in which the average (001) grain diameter may be 1 to 50 times the thickness of the electrical steel sheet, and the average (001) grain diameter may be in a range of 0.3 to 5 mm.

The electrical steel sheet according to an example of the present disclosure is characterized in that an area fraction of (001) grains thereof is 80% or more, a magnetic flux density (B₅₀) thereof is 1.70 Tesla or more, and a ratio of sheet thickness to iron loss (W_{15/50}) thereof is in a range of 4 to 20 Watts/kg/mm.

### Advantageous Effects

An electrical steel sheet composed of (110) texture according to the present disclosure contains Si in a content of 2.0% to 4.0%, Mn in a content of more than 0.5% and 2.0% or less, S in a content of 0.01% or less (excluding 0%), C in a content of 0.01% or less (excluding 0%), N in a content of 0.01% or less (excluding 0%), and the residual being composed of Fe and unavoidable impurities. The steel sheet is composed of (001) crystal grains, has an angle (θ) of 0°≤θ≤8° between a rolling direction and a [100] crystal orientation in (001) texture exhibiting a maximum face, and has a thickness of 0.05 to 0.25 mm after two-stage cold rolling, so that the steel sheet has an area fraction of (001) grains of 80% or more, a magnetic flux (B₅₀) of 1.70 Tesla or more, and a ratio of sheet thickness to iron loss (W_{15/50}) of 4 to 20 Watts/kg/mm.

Meanwhile, it is noted that effects that are not explicitly mentioned herein but can be anticipated from the technical features of the present disclosure or potential effects of the present disclosure should be regarded as the effects described in the specification of the present disclosure.

### DESCRIPTION OF DRAWINGS

FIG. 1 is a phase diagram showing changes in the area of each of ferrite (α), MnS precipitates, and austenite (γ) at each temperature depending on the amount of Mn, which is an austenite (γ) stabilizing element, in a Fe-2% Si-0.002% S alloy system, in which the areas are calculated with the ThermoCalc program including a built-in TCFE 9 database that is commonly used for phase diagram calculation.

FIG. 2 is a phase diagram showing changes in the area of each of ferrite (α), MnS precipitates, and austenite (γ) at each temperature depending on the amount of Mn, which is an austenite (γ) stabilizing element, in a Fe-3.1% Si-0.002% S alloy system, in which the areas are calculated with the ThermoCalc program including a built-in TCFE 9 database that is commonly used for phase diagram calculation.

FIG. 3 is a phase diagram showing changes in the area of each of ferrite (α), MnS precipitates, and austenite (γ) at each temperature depending on the amount of Mn, which is an austenite (γ) stabilizing element, in a Fe-4% Si-0.002% S alloy system, in which the areas are calculated with the ThermoCalc program including a built-in TCFE 9 database that is commonly used for phase diagram calculation.

FIG. 4 shows changes in the content of Si atoms and the content of Mn atoms along a depth direction of a steel sheet from the surface of after final annealing in E-grade steel with a (001)-grain area fraction of 98% and a steel sheet thickness of 0.1 mm (100 μm) in Example 7 below.

FIG. 5 shows the orientation distribution function (ODF) for a 0.05 mm thick D steel sheet with a grain area fraction of 98% after two-stage cold rolling and final anneal in Example 3 below, in which the steel sheet has (001)<1200>+(001)<230> texture.

FIG. 6 is a diagram showing the ODF of FIG. 5 as an etch pit structure.

### BEST MODE

Hereinafter, the present disclosure will be described in detail. The embodiments and drawings described herein are provided as examples to fully and sufficiently convey the spirit of the present disclosure to those skilled in the art. In the flowing description, unless otherwise defined, all terms including technical and scientific terms used herein have the same meaning as commonly understood by those who are ordinarily skilled in the art to which this disclosure belongs. Further, when it is determined that the detailed description of the known art related to the present disclosure might obscure the gist of the present disclosure, the detailed description thereof will be omitted. Furthermore, various elements and regions in the drawings are schematically illustrated. Accordingly, the technical idea of the present disclosure is not limited by the relative sizes of elements or spacings illustrated in the accompanying drawings.

Additionally, unless otherwise stated herein, “%” means “% by weight”.

The term “(001) plane” used herein refers to a plane in which crystallographic (001) planes of the crystal grains constituting the electrical steel sheet are parallel to the sheet surface of an electrical steel sheet. Here, the term “sheet surface” of an electrical steel sheet refers to an xy plane in a coordinate system with the x axis representing a rolling direction (RD direction) of the steel sheet and the y axis representing a transverse direction (TD direction).

The (001) texture analysis is performed by calculating and analyzing the surface intensity for each orientation using the orientation distribution function (OFD) based on electron backscatter diffraction (EBD). In addition, the area fraction of (001) crystal grains was determined using the etch-pit method and an optical microscope.

Additionally, the average grain diameter was obtained using a conventional grain size calculation method and an optical microscope.

The term “surface intensity of (001) texture” used herein refers to the relative intensity of (001) texture with respect to the surface intensity (1) of a random texture without any type of texture. For example, the surface intensity of (001) texture means the surface intensity of an orientation exhibiting the maximum surface intensity among the orientations shown in an orientation distribution function image (ODF image, φ₂2=45° section).

Conventionally, to lower the iron loss of electrical steel sheets, alloying elements with high resistivity, such as Si, Al, and Mn, were added to steel. However, this method had a disadvantage of reducing the magnetic flux density. In particular, excessive addition of Mn results precipitation of MnS which hinders grain growth and interferes with the movement of magnetic domains, thereby increasing iron loss and reducing magnetic flux density. Therefore, conventionally, the content of Mn was limited to 0.3%, but it was difficult to increase both the iron loss and the magnetic flux density at the same time.

Accordingly, the present inventors have repeatedly studied methods to increase magnetic flux density while lowering iron loss, have discovered that iron loss characteristics and magnetic flux density characteristics can be improved simultaneously when an electrical steel sheet is manufactured to satisfy the following configuration, and have completed the disclosure based on the finding.

Specifically, an electrical steel sheet according to one example of the present disclosure contains Si at a concentration of 2.0% to 4.0%, Mn at a concentration of more than 0.5% and 2.0% or less, S at a concentration of 0.01% or less (excluding 0%), C at a concentration of 0.01% or less (excluding 0%), N at a concentration of 0.01% or less (excluding 0%), and the residual including Fe and unavoidable impurities, in which the steel sheet is composed of (001) crystal grains, has a thickness of 0.05 to 0.25 mm after two-stage cold rolling, and has an angle (θ) 0°≤θ≤8° between a rolling direction and [100] crystal orientation exhibiting the maximum surface intensity in (001) texture.

When the conditions are satisfied, the electrical steel sheet composed of (001) texture according to the present disclosure has an (001)-grain area fraction of more than 80%, which gives a magnetic flux density (B₅₀) of 1.70 Tesla or more and a ratio of steel sheet thickness to iron loss (W_{15/50}) of 4 and 20 Watts/kg/mm.

These excellent properties are achieved by precipitating a large amount of MnS during reheating and annealing a steel sheet having an excessive Mn content that is more than 0.5% and 2.0% or less to prevent S from being concentrated in a surface layer of the steel sheet during final annealing, which prevents the surface energy of {111} crystal plane from being lower than the surface energy of (001) crystal plane.

During the final annealing, MnS precipitates that interfere with the growth of (001) grains are decomposed by a reducing gas, so that Mn cations (Mn²⁺) are dissolved and changed back into an atomic state (Mn) in the steel sheet, and S anions (S²⁻) react with the reducing gas and is thus removed as a gaseous phase gas such as hydrogen sulfide. As a result, the growth of (001) crystal grains can be maximized. In other words, when most of the excessive MnS precipitates are decomposed and the produced Mn cations are dissolved again to be atomic manganese, the content of atomic Mn in the slab and the content of atomic Mn the finally annealed steel sheet become almost the same.

Through this, it is possible to obtain an electrical steel sheet having a (001) grain area fraction of 80% or greater, a flux density (_{B50}) of 1.70 Tesla or greater, and a steel thickness to iron loss (_{W15/50}) ratio of 4 to 20 Watts/kg/mm. More preferably, the electrical steel sheet according to an example of the present disclosure may have a (001) grain area fraction of 90% or more, and even more preferably 95% or more. The magnetic flux density (B₅₀) may be 1.72 Tesla or more, more preferably 1.74 Tesla or more, and most preferably 1.76 Tesla or more. The upper limit is not particularly limited but may be, for example, 2.0 Tesla. The ratio of steel sheet thickness to iron loss (W_{15/50}) may be in a range of 4 to 20 Watts/kg/mm.

To achieve this, it is important to add excess Mn of more than 0.5% to 2.0% or less, and to carefully control the manufacturing process conditions so that MnS can be quickly decomposed during final annealing after reheating and annealing the slab to sufficiently precipitate MnS. This will be described in more detail when describing about an alloy composition and manufacturing method for the electrical steel sheet.

The electrical steel sheet according to an example of the present disclosure may have (001) grains having a large diameter penetrating through the electrical steel sheet in a thickness direction. The average diameter of the (001) grains may be 1 to 50 times the thickness of the electrical steel sheet, and the average diameter of the (001) grains may be in a range of 0.3 to 5 mm. When the average diameter is in the range, both low iron loss and high magnetic flux density characteristics can be secured. More specifically, the average {100} grain diameter may be in a range of 0.3 to 5 mm.

In addition, in the electrical steel sheet according to an example of the present disclosure, the angle (θ) between the rolling direction and the [100] crystal orientation in the (001) texture, which represents the maximum surface intensity, satisfies 0°≤θ≤8°. This means that the main texture representing the maximum surface intensity of the electrical steel sheet is close to (001) [010]. The angle (θ) between the rolling direction and the [100] crystal orientation exhibiting represents the maximum surface intensity in the (001) texture satisfies 0°≤θ≤7° and more preferably satisfies 0°≤θ≤5°. In addition, the surface of the steel sheet is characterized by the absence of a demanganese layer and a surface oxide film. For these reasons, both low iron loss and high magnetic flux density characteristics can be secured.

Hereinafter, the alloy composition of the electrical steel sheet according to an embodiment of the present disclosure will be described in detail.

### Si: 2.0% to 4.0%

Si is a main element added to increase the resistivity of steel and reduce eddy current loss of iron loss. With an Si content of less than 2.0%, the (001) texture does not easily develop due to the presence of austenite (γ) phase during heat treatment, which makes it difficult to obtain high magnetic flux density extremely low iron loss characteristics. On the other hand, with an Si content of over 4.0%, sheet fracture occurs during cold rolling. Therefore, the present disclosure limits the Si content to a range of 2.0% to 4.0% by weight.

Mn: More than 0.5% but Less than 2.0%

Mn, along with Si and Al, has a strong effect of lowering iron loss by increasing resistivity, but when it combines with sulfur to form MnS precipitates and is present inside the electrical steel sheet, it not only hinders (001) grain growth but also interferes with the movement of magnetic domains, thereby causing an increase in iron loss and a decrease in magnetic flux density. Therefore, for existing non-oriented electrical steel sheets composed of {111} texture, Mn is added in an amount of up to 0.3%. For this reason, non-oriented electrical steel sheets composed of {111} texture are subjected to short final annealing in a temperature range of 900° C. to 1100° C. for a duration of less than 3 minutes to suppress MnS generation as much as possible.

Therefore, it is necessary to understand the characteristics of the heat treatment process used in the present disclosure which provides an electrical steel sheet composed of (001) texture, the electrical steel sheet having greatly reduced iron loss due to the addition of a large amount of Mn and a highly integrated area fraction of (001) grains.

In a coordinate system with the x-axis as the time axis and the y-axis as the temperature axis, an MnS production curve is C-curved, and the C curve moves to a relatively high temperature and short time region as the amount of Mn and S added increases. Due to the existence of the C curve, precipitation of MnS occurs in the steel sheet during cooling after hot rolling, and additional production of MnS is unavoidable while the temperature of the cold rolled steel sheet is raised to the final annealing temperature at a certain heating rate and the final annealing temperature is maintained.

When MnS precipitates that inhibits the growth of (001) grains exist in the steel sheet until the end of the final annealing, it is impossible to obtain an electrical steel sheet with a high (001) area fraction.

On the other hand, during final annealing performed in a reducing gas atmosphere and in ferrite (α)+MnS precipitate temperature conditions where no austenite (γ) phase exists and only ferrite (α) phase or a mixed phase of ferrite (α) and MnS precipitates exists, hydrogen (H₂) in the atmosphere reacts with the MnS precipitates and produces hydrogen sulfide (H₂S) gas. That is, the MnS precipitates are decomposed by the reaction “MnS+H2→H2S+Mn”. The hydrogen sulfide generated through the decomposition reaction is absorbed in the reducing atmosphere, and Mn is dissolved into the steel sheet. While the final annealing continues, the MnS decomposition reaction continues, and eventually, after a certain critical time, the MnS precipitates that hinder (001) grain growth in the steel sheet may disappear. From this point on, the (001) grains showing the lowest surface energy encroach on the {110} or {111} grains with relatively high surface energy, thereby forming an electrical steel sheet composed of (001) grains.

In particular, in the MnS decomposition reaction by hydrogen in this reducing gas atmosphere, as the temperature increases, the decomposition speed increases, and the end time of the decomposition reaction comes early. However, when Mn and S contents are high and the thickness of the steel sheet is large, the time required for the decomposition reaction of MnS, which is generated in large quantities, considerably increases. Therefore, when the steel sheet is thick, the S content must be lowered, the heat treatment time must be increased, or the heat treatment temperature must be increased to reduce the amount of MnS generated.

Therefore, in order to easily manufacture an electrical steel sheet composed of (001) texture in which a large amount of Mn is contained to significantly reduce iron loss and which has a high (001) area fraction to exhibit low iron loss and high magnetic flux density, the final annealing needs to be performed at or above a certain critical temperature in a reducing gas atmosphere for a sufficient duration so that the the decomposition of MnS is accelerated to reduce the decomposition reaction time, and the growth of (001) grains can be facilitated.

As a specific example, an electrical steel sheet according to an embodiment of the present disclosure may satisfy the following Relational Expression 1.

[Mn]₀×0.95≤[Mn]₁≤[Mn]₀×1.05 [Relational Expression 1]

(In Relational Expression 1, [Mn]₀ is the content (% by weight) of manganese atoms (Mn) in the slab, and [Mn]₁ is the content (% by weight) of manganese atoms (Mn) in the steel sheet after final annealing.)

As described above, in the case of the electrical steel sheet manufactured with permanganese according to an embodiment of the present disclosure, since the MnS precipitate is decomposed during final annealing after MnS precipitation, and Mn is dissolved back into steel, the content of Mn in the slab is almost equal to the content of Mn in the steel sheet having undergone the final annealing. Here, [Mn]₁ may be the average value of the Mn contents measured at respective points OT (surface), ( 1/100)T, ( 1/20)T, ( 1/10)T, and ½T (midway point) that are depths in a thickness direction T, and the upper limit is set to [Mn]₀×1.05, taking into account the measurement error during the experiment.

In the present disclosure, in order to easily manufacture an electrical steel sheet composed of {100} texture with greatly reduced iron loss, at least 0.5% of Mn needs to be added to a slab. In addition, in order for a thick steel sheet to have a high (110) area fraction, final annealing for the Mn-added slab needs to be performed at a relatively high temperature for a sufficiently long duration. However, when the Mn content exceeds 2.0%, the (001) texture cannot sufficiently develop, and the magnetic properties may be poor due to the formation of austenite (γ) phase during the final annealing. Therefore, in order to prevent the inhibition of {100} texture development attributable to the formation of austenite (γ) phase and to maximize iron loss reduction by increasing the density of the (001) texture, the present disclosure proposes that Mn is added at a concentration of more than 0.5% but not greater than 2.0%.

### S: 0.01% or Less (Excluding 0%)

When S is added in a large amount, excessive precipitation of MnS occurs during the cooling process following the hot rolling and during final annealing, and thus the growth of {100} grains is inhibited. Therefore, final annealing needs to be performed at a relatively higher temperature to facilitate the growth of (001) grains.

However, when S is added in a large amount, since a reaction of producing MnS actively occurs, the interface area between a base phase and an MnS region increases, S atoms segregate to the interface between the base phase and the MnS region rather than to the surface of the steel sheet during the final annealing, thereby facilitating the formation of MnS. As a result, the amount of surface segregation of S decreases and the surface energy of the {110} crystal plane becomes smaller than that of the (001) crystal plane, so that the growth of {110} grains is promoted rather than the growth of (001) grains, and eventually, an electrical steel sheet composed of {110} crystal grains is produced. That is, the produced electrical steel sheet is unsuitable for used in motor iron cores, and this becomes worse as the steel sheet becomes thicker. Therefore, in the present disclosure, the amount of S added is limited to 0.01% or less.

### C: 0.01% or Less (Excluding 0%)

Adding a large amount of C expands the austenite (γ) region to inhibit the growth of (001) grains during final annealing. In addition, C combines with Fe and Ti to form carbides, which has the effect of lowering magnetic flux density and increasing iron loss. Therefore, in the present disclosure, the C content is limited to 0.01% or less.

### N: 0.01% or Less (Excluding 0%)

N strongly combines with Al, Ti, etc. to form nitrides, thereby suppressing (001) grain growth and deteriorating magnetic properties. When N is contained in a large amount, the austenite (γ) region expands during final annealing, resulting in inhibiting the growth of (001) grains. Therefore, it is desirable to contain C as little as possible. In the present disclosure, the amount of N added is limited to 0.01% by weight or less.

In addition to the above-mentioned elements, the remainder is composed of Fe and other inevitable impurities.

The alloying elements and content ranges thereof not to impair the effect of the present disclosure will be described below.
Al: 0.1% or less
W, V, Cr, Co, Ni, Mo: 1% or less each
Cu: 0.5% or less
Nb: 0.5% or less
Sb, Se, As: 0.05% or less for each
B: 0.005% or less
P: 0.2% or less

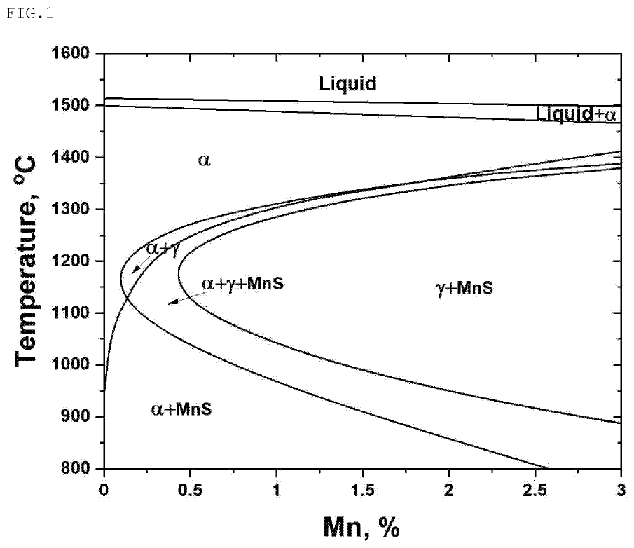

FIG. 1 is a diagram showing changes in the presence of ferrite (α), MnS precipitates, and austenite (γ) as a function of temperature with increase in the content of Mn, which is an austenite (γ) stabilizing element, in an Fe-2% Si-0.002% S alloy system containing S. FIG. 1 shows a ferrite (α)+MnS region in the Fe-2% Si-0.002% S alloy system in which the austenite (γ) phase is not present in a temperature range of 1000° C. to about 1035° C. even when Mn is added in an amount of more than 0.5% and 0.7% or less. As the amount of S added increases, the amount of MnS precipitated increases.

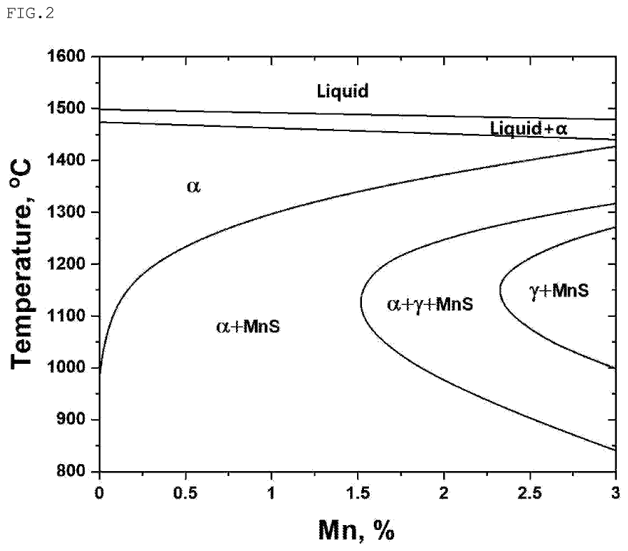

FIG. 2 is a diagram showing changes in the presence of ferrite (α), MnS precipitates, and austenite (γ) as a function of temperature with increase in the content of S, which is an austenite (γ) stabilizing element, in an Fe-3.1% Si-0.002% S alloy system containing S. When the amount of Si increases up to 3.1% and Mn is added in an amount of about 1.4%, the austenite (γ) phase does not exist in the whole heat treatment temperature range, and a ferrite (α)+MnS region or a ferrite (α) single phase is shown.

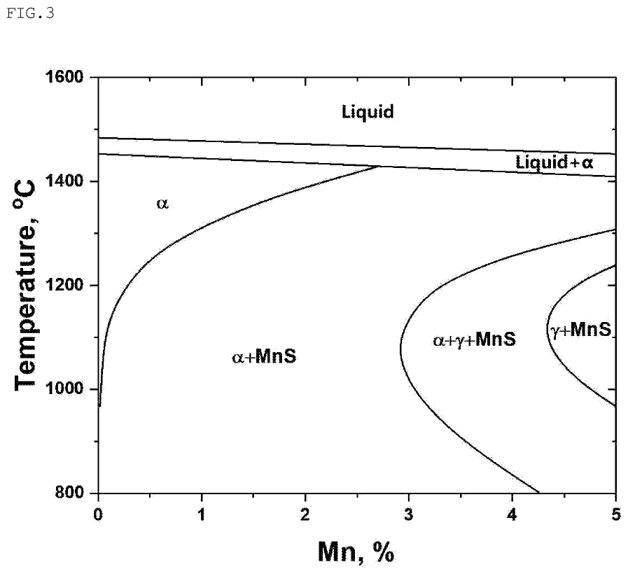

FIG. 3 is a diagram showing changes in the presence of ferrite (α), MnS precipitates, and austenite (γ) as a function of temperature with increase in the content of Mn, which is an austenite (γ) stabilizing element, in an Fe-4% Si-0.002% S alloy system containing S. The Fe-4% Si-0.002% S alloy system being rich in Si, which is a ferrite (α) stabilizing element, exhibits a ferrite (α)+MnS region or a ferrite (α) single phase with no austenite (γ) phase in the whole temperature range, even though Mn is added in a significantly large amount of about 2.8%. In similar to the alloys shown in FIGS. 2 and 3, the amount of MnS precipitated increases with an increasing in S content. As can be seen from FIGS. 1, 2, and 3, as the amount of Si, which is a strong ferrite (α) stabilizing element, increases, the temperature range for the ferrite (α)+MnS region dramatically expands.

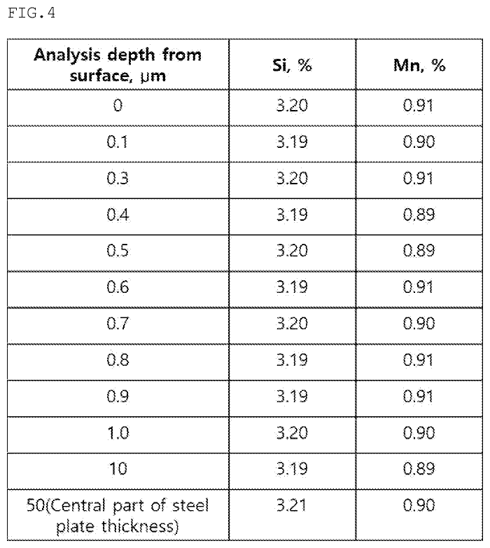

FIG. 4 is a diagram illustrating changes in the content of Si and Mn from the surface to the interior of a steel sheet after final annealing, in which the steel sheet is an E-grade steel sheet having a (001) area fraction of 98% and a steel sheet thickness of 0.1 mm (100 μm) in Example 7 below. Regardless of the depth of the steel sheet, it can be seen that the content of Si and Mn in the steel sheet after the final annealing is almost the same as the content of Si and Mn in the slab. This shows that the precipitated MnS is almost completely decomposed. In addition, it is confirmed that there is no demanganese layer and surface oxide film on the surface of the steel sheet of the present disclosure in that a change in the content of Si and Mn between the surface and an inside position of the steel sheet is not observed regardless of the depth of the steel sheet.

A method of manufacturing the electrical steel sheet with such excellent iron loss characteristics and magnetic flux density characteristics includes: a) reheating a slap containing, Si of 2.0% to 4.0% by weight, Mn of more than 0.5% and less than 2.0% by weight, S of 0.01% or less (excluding 0%) by weight, C of 0.01% or less (excluding 0%) by weight, N of 0.01% or less (excluding 0%) by weight, and the balance composed of Fe and other unavoidable impurities to a temperature in a ranGe of 950° C. to 1250° C.;

b) hot rolling the reheated slab to obtain a hot rolled steel sheet;

c) obtaining an annealed hot rolled steel sheet by heating the hot rolled steel sheet to a temperature range of 800° C. to 1250° C. where no austenite (γ) phase exists and a ferrite (α) single phase or a ferrite (α)+MnS precipitate mixed phase in which ferrite (α) and MnS precipitates are mixed exists, and then cooling the heated hot rolled steel sheet;

d) obtaining a two-stage cold rolled steel sheet by primarily cold rolling the annealed hot rolled steel sheet, then subjecting the resulting steel sheet to an intermediate annealing treatment in which the steel sheet is heated up to a temperature within which no austenite (γ) phase is present and the ferrite (α) single phase or the ferrite (α)+MnS precipitates mixed phase exists, within a temperature range of 650° C. to 1250° C. and is then cooled, and then secondarily cold rolling the resulting steel sheet; and

e) performing final annealing on the two-phase cold-rolled steel sheet at a temperature at which the austenitic (γ) phase is not present and the ferrite (α) single phase or the ferrite (α)+MnS precipitates mixed phase is present in a temperature range of 1000° C. to 1250° C. and 1 atm reducing gas atmosphere.

When the reheating, annealing, cold rolling, and final annealing processes of the slab containing Mn in a large amount (for example, more than 0.5% and 2.0% or less) are optimized as described above, it is possible to produce an electrical steel sheet composed of (001) grains, having a thickness of 0.05 to 0.25 mm by two-stage cold rolling, and having an angle θ that is formed between a rolling direction and [100] crystal orientation in the (001) texture and which satisfies 0°≤θ≤8°.

Herein after, a method of manufacturing a (001) electrical steel sheet according to one example of the present disclosure will be described in detail.

First, an electrical steel slab satisfying the above-described composition is reheated to 950° C. to 1250° C. and then hot rolled. When the reheating temperature is lower than 950° C., excessive force is required for hot rolling, which may cause strain on equipment or make it difficult to perform smooth hot rolling. When the reheating temperature exceeds 1250° C., extreme surface oxidation on the slab occurs. Therefore, the reheating temperature is limited to be in the range of 950° C. to 1250° C.

Next, the reheated slab is hot rolled to obtain a hot rolled steel sheet.

The hot rolled steel sheet thus obtained may be pickled and cold rolled without annealing, or the hot rolled steel sheet may be annealed before cold rolling to improve magnetic properties.

The annealing temperature of the hot rolled steel sheet may be set to a temperature at which an austenite (γ) phase does not exist, and a ferrite (α) single phase or a ferrite (α)+MnS precipitate mixed phase in which ferrite (α) and MnS precipitates are mixed exist, within the range of 800° C. to 1250° C. When the annealing temperature is determined to be within the mentioned range, the precipitation of MnS is active and the S content in the steel can be minimized. That is, the growth of (001) grains is more promoted than that of {111} grains during final annealing. On the other hand, when the annealing temperature of the hot-rolled steel sheet is lower than 800° C., the grain texture is not uniform. When the annealing temperature exceeds 1250° C., surface defects of the hot-rolled steel sheet become excessive due to excessive grain growth.

The hot rolled steel is pickled and then cold rolled in the usual way.

The pickled hot rolled steel can be subjected to two-stage cold rolling. That is, the pickled hot rolled steel undergoes primary cold rolling, intermediate annealing, and secondary cold rolling in sequence. In the case of two-stage cold rolling, the secondary cold rolling rate may be 25% to 90%.

The intermediate annealing may be performed at a temperature in the range of 650° C. to 1250° C. At the temperature, no austenite (γ) phase exists, and a ferrite (α) single phase or a ferrite (α)+MnS precipitate mixed phase in which ferrite (α) and MnS precipitates are mixed exist. When the temperature for the intermediate annealing is determined to be within the mentioned range, the precipitation of MnS is active and the S content in the steel can be minimized. That is, the growth of (001) grains is more promoted than that of {111} grains during final annealing. When the intermediate annealing temperature is lower than 650° C., recrystallization is difficult to occur in the cold rolled steel sheet, and when the temperature is higher than 1250° C., (001) grains are difficult to grow during final annealing due to excessive grain growth.

Next, the finally cold-rolled steel sheet is subjected to final annealing performed at a temperature at which no austenite (γ) phase exists and a ferrite (α) single phase or a ferrite (α)+MnS precipitates mixed phase exists, within the range of 1000° C. to 1250° C. under a reducing gas atmosphere of 1 atm. In this case, the temperature rising rate up to the final annealing temperature may be from 25° C./h to 14400° C./h, and the final annealing may be performed for 8 to 48 hours at the final annealing temperature. Performing the final annealing for the sufficient time enables most of the MnS precipitates inside the cold rolled steel sheet to be decomposed, and thus interference with the growth of (001) grains caused by the MnS precipitates can be prevented.

When the final annealing is performed at a temperature lower than 1000° C., it is difficult to obtain electrical steel sheets with a high density (001) area fraction due to the slow decomposition reaction of MnS precipitates that hinder (001) grain growth. On the other hand, when the temperature exceeds 1250° C., magnetic and mechanical properties may be deteriorated due to excessive grain growth.

As described above, in the method of manufacturing an electrical steel sheet composed of (001) grains according to one embodiment of the present disclosure, final annealing for a cold rolled steel sheet is performed at a temperature at which no austenite (γ) phase exists and a ferrite (α) single phase or a ferrite (α)+MnS precipitates mixed phase exists under a 1-atm reducing gas atmosphere for a sufficiently long time. By the method, it is possible to easily produce an electrical steel sheet composed of (001) grains.

Conventional non-directional electrical steel sheets composed of {111}<UVW> texture, which are applied to current motor iron cores, show a difference of about ±5% with respect to the average value depending on the direction when the magnetic properties are measured while changing measurement angles from 0° to 45° relative to the rolling direction. Therefore, due to this difference, technically, a ring type test specimen should be used to represent the average value of the electrical steel sheet, but in general, a rectangular steel sheet test specimen and a DC magnetometer are used to measure the magnetic properties in the rolling direction and the direction perpendicular to the rolling direction, and the measurements are used as the representative values of the electrical steel sheet.

As can be seen in academic literature 2, the magnetic properties of electrical steel sheets composed of (001) [010] texture increase as the deviation angle from the rolling direction increases from 0° to 45°, the magnetic flux density dramatically changes from the maximum value to the minimum value, and the iron loss changes from the minimum value to the maximum value. In addition, due to the unique characteristics of electrical steel composed of (001) crystalline grains, as the deviation angle is further increased from 45° to 90°, the flux density increases rapidly from the minimum to the maximum, and the iron loss decreases from the maximum to the minimum.

Therefore, due to the characteristics of the electrical steel sheet composed of (001) crystal grains, the magnetic properties of the present disclosure composed of (001) texture can be measured by the method of measuring magnetic properties of a non-oriented electrical steel sheet in the direction parallel to the rolling direction and in the direction perpendicular to the rolling direction. Therefore, in order to accurately represent the magnetic properties of the present disclosure composed of (001) crystal grains, the average value of the magnetic property was measured using a ring type test specimen as in an example below. Magnetic properties were measured by cutting a ring-type steel sheet with an inner diameter of 15 mm and an outer diameter of 30 mm from a final annealed steel sheet, annealing the ring-type steel sheet for stress-relieving in an argon (Ar) atmosphere at 800° C. for 1 hour, and measuring the iron loss and magnetic flux density. The results are shown in Table 3 below. Magnetic properties were measured by cutting a ring-type steel sheet with an inner diameter of 25 mm and an outer diameter of 40 mm from a final annealed steel sheet, annealing the ring-type steel sheet for stress-relieving in an argon (Ar) atmosphere at 800° C. for 1 hour, and measuring the iron loss and magnetic flux density. The results are shown in Table 3 below. As can be seen with reference to one embodiment, electrical steel sheets mostly composed of (001) crystalline grains exhibit the average magnetic properties regardless of changes in process variables when the composition and thickness are the same.

The present disclosure product composed of (001) texture is then subjected to insulation coating and then shipped to the customer. The insulation coating may be an organic coating, an inorganic coating, or an organic/inorganic composite coating. Optionally, a tension coating may be provided to further reduce iron loss. The customer may manufacture motor iron cores using the electrical steel sheet composed of (001) texture, may perform stress-relieve annealing on the motor iron cores at around 800° C. for 1 to 2 hours, cool the annealed motor iron cores to 400° C. in a furnace, and then take the motor iron cores from the furnace for use.

Hereinafter, a method of manufacturing an electrical steel sheet composed of (001) texture, according to the present disclosure, will be described in detail with reference to examples. However, the examples described below are provided only to illustrate the present disclosure and thus should not be construed as limiting to the scope of the present disclosure.

TABLE 1

| Steel grade | C | Si | Mn | S | N |
|---|---|---|---|---|---|
| A | 0.0026 | 1.5 | 0.5 | 0.0045 | 0.0033 |
| B | 0.0013 | 2.5 | 0.6 | 0.0006 | 0.0013 |
| C | 0.0018 | 2.5 | 0.7 | 0.0021 | 0.0016 |
| D | 0.0015 | 3.2 | 0.8 | 0.0005 | 0.0023 |
| E | 0.0024 | 3.2 | 0.9 | 0.0097 | 0.0011 |
| F | 0.0018 | 3.5 | 1.3 | 0.0010 | 0.0020 |

### Examples 1 to 8 and Comparative Example 1

Slabs having respective compositions A to F of Table 1 (% by weight, the balance being Fe) were heated to 1150° C. and hot rolled to a thickness of 2.5 mm. The tot-rolled steel sheets were subjected to annealing at 1050° C. for 2 minutes, primary acid pickling, primary cold rolling, intermediate annealing at 1050° C. for 2 minutes, and secondary cold rolling to have a thickness of 0.05 mm, 0.10 mm, or 0.2 mm (secondary cold rolling rate of 50%). The final annealing of the cold rolled steel sheets was performed according to the conditions shown in Table 2 below under a 1-atm hydrogen (H₂) atmosphere.

### Comparative Examples 2 to 4

Slabs having composition E of Table 1 (% by weight, the balance being Fe) were heated to 1150° C. and hot rolled to a thickness of 2.5 mm. The hot-rolled steel sheets were annealed at 1050° C. for 2 minutes, then pickled, and then and single-stage cold rolled to a thickness of 0.1 to 0.35 mm. The final annealing of the cold rolled steel sheets was performed according to the conditions shown in Table 2 below under a 1-atm hydrogen (H₂) atmosphere.

TABLE 2

| | | | Final annealing | | |
|---|---|---|---|---|---|
| | | Cold | condition | | Seet |
| | Steel | rolling | Temperature | Time | thickness, |
| | grade | method | (° C.) | (hr) | mm |
| Comparative | A | 2-stage | 1050 | 20 | 0.10 |
| Example 1 | | | | | |
| Example 1 | B | 2-stage | 1050 | 20 | 0.10 |
| Example 2 | C | 2-stage | 1050 | 20 | 0.10 |
| Example 3 | D | 2-stage | 1200 | 13 | 0.05 |
| Example 4 | D | 2-stage | 1200 | 13 | 0.2 |
| Example 5 | E | 2-stage | 1150 | 12 | 0.10 |
| Example 6 | F | 2-stage | 1150 | 12 | 0.10 |
| Example 7 | E | 2-stage | 1200 | 13 | 0.10 |
| Example 8 | F | 2-stage | 1200 | 13 | 0.10 |
| Comparative | E | 1-stage | 1200 | 10 | 0.35 |
| Example 2 | | | | | |
| Comparative | E | 1-stage | 1000 | 10 | 0.10 |
| Example 3 | | | | | |
| Comparative | E | 1-stage | 1000 | 10 | 0.35 |
| Example 4 | | | | | |

For each specimen prepared in the above examples and comparative examples, the texture, surface intensity, and average grain diameter were investigated in an area of 5 mm×12 mm through EBSD. In addition, for each steel sheet surface with dimensions of 10 mm (width)×100 (rolling direction), the (001) area fraction, the angle θ between the rolling direction and the [100] orientation exhibiting the maximum surface intensity in the (001) texture, and the average grain diameter were investigated using an etch pit method and an optical microscope. In addition, the contents of Si and Mn were analyzed by varying the analysis depth from the surface of the steel sheet in the thickness direction using an energy-dispersive X-ray (EDS) mounted on a scanning electron microscope. The results are shown in FIG. 4.

TABLE 3

| | | (001) | Iron | | | W_{15/50}/ | |
|---|---|---|---|---|---|---|---|
| | | grain | loss, | Flux | Average | sheet | |
| | | area | W_{15/50}, | density, | grain | thickness, | |
| | Steel | fraction, | Watts/ | B₅₀, | diameter, | Watts/ | |
| | grade | % | kg | Tesla | mm | kg/mm | θ |
| Comp. | A | 5 | 3.27 | 1.688 | 0.30 | 32.7 | — |
| Exam. 1 | | | | | | | |
| Exam. 1 | B | 95 | 1.13 | 1.798 | 0.63 | 11.3 | 0 |
| Exam. 2 | C | 100 | 1.10 | 1.795 | 0.51 | 11.0 | 0 |
| Exam. 3 | D | 98 | 0.91 | 1.762 | 0.90 | 18.2 | 2.9 |
| Exam. 4 | D | 99 | 1.08 | 1.759 | 3.50 | 5.4 | 6.2 |
| Exam. 5 | E | 95 | 0.94 | 1.763 | 0.75 | 9.4 | 0 |
| Exam. 6 | F | 100 | 0.78 | 1.725 | 3.10 | 7.8 | 0 |
| Exam. 7 | E | 98 | 0.95 | 1.761 | 0.59 | 9.5 | 0 |
| Exam. 8 | F | 100 | 0.76 | 1.724 | 0.75 | 7.6 | 7.3 |
| Comp. | E | 6 | 2.59 | 1.624 | 0.71 | 7.4 | — |
| Exam. 2 | | | | | | | |
| Comp. | E | 7 | 1.88 | 1.630 | 0.29 | 18.8 | — |
| Exam. 3 | | | | | | | |
| Comp. | E | 5 | 2.61 | 1.610 | 0.67 | 7.5 | — |
| Exam. 4 | | | | | | | |

Referring to Tables 1 to 3, the two-stage cold rolled steel grades B to F showed a (001) area fraction of more than 95% and had excellent magnetic properties. In addition, among the magnetic properties of the steel grades to which a large amount of Mn was added, the iron loss was significantly lower than that of the steel grade disclosed in Korean Patent Application Publication No. 10-1842417. In addition, the angle (θ) formed between the rolling direction and the [100] crystal orientation in the (001) texture was in the range of 0°≤θ≤7.3°. On the other hand, steel grade A had poor magnetic properties due to its extremely low (001) area fraction.

In addition, in the case of Comparative Example 2 using steel grade E having the same composition as in Example 7, the area fraction was extremely low because the electrical steel sheet was manufactured to have a thickness of 0.35 mm by single-stage cold rolling, and thus the magnetic properties were also poor. In addition, Comparative Examples 3 and 4 using the same steel grade E also showed poor magnetic properties due to an extremely low (001) area fraction. These poor magnetic properties are because, in the case of a low final annealing temperature, the MnS decomposition reaction caused by hydrogen present in the hydrogen atmosphere is insignificant and the resulting MnS precipitates inside the steel sheet extremely suppress the growth of (001) grains. The poor magnetic properties are also because, in the case of a thick steel sheet, the time of the MnS decomposition reaction caused by hydrogen in the hydrogen atmosphere is increased, it is difficult to completely decompose the MnS precipitates during the limited final annealing time, and as a result, the remaining MnS precipitates inside the steel sheet significantly suppress the growth of (001) grains.

FIG. 5 shows (001)<1200>+(001)<230> texture as an orientation distribution function (ODF) for a 0.05 mm thick D steel sheet having an area fraction of 98% of the grains of Example 3.

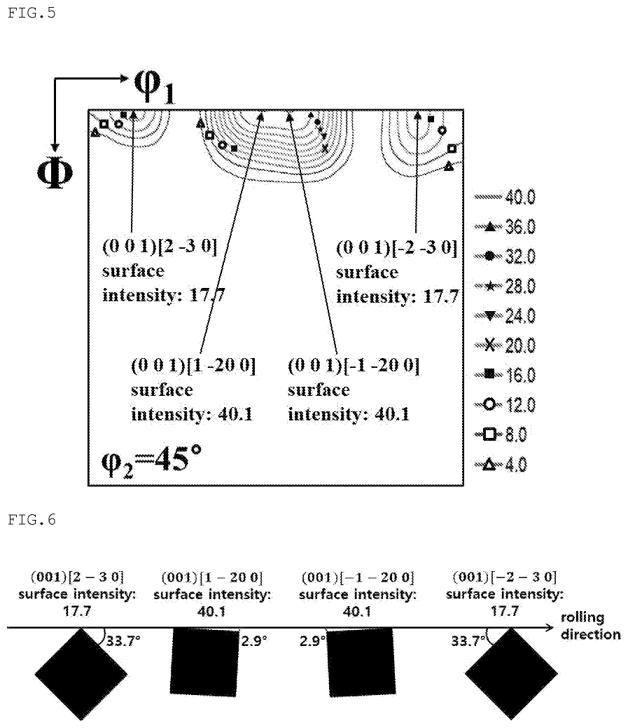

FIG. 6 is a view showing the texture of FIG. in the form of an etch pit, in which the angle (θ) formed between the rolling direction and the [100] crystal orientation exhibiting the maximum surface intensity in the (001) texture is 2.9°. The texture intensity and the angle between the rolling direction and the [001] orientation, which is an axis for easy magnetization, varied depending on the secondary cold rolling rate during two-stage rolling.

The present disclosure has been described with reference to some specific examples, features, and drawings. However, the specific examples, features, and drawings are only for illustrative purposes and are not intended to limit the scope of the present disclosure, and it will be appreciated by those skilled in the art that various modifications and changes are possible on the basis of the description of the examples given above.

Therefore, the spirit of the present disclosure is not limited to the specific examples described above, and all forms defined by the appended claims and all equivalents and modifications thereto fall within the scope of the present disclosure.

1. An electrical steel sheet comprising, based on weight, Si in a content of 2.0% to 4.0%, Mn in a content of more than 0.5% and 2.0% or less, S in a content of 0.01% or less (excluding 0%), C in a content of 0.01% or less (excluding 0%), N in a content of 0.01% or less (excluding 0%), and the balance comprising Fe and unavoidable impurities, wherein the iron steel sheet is composed of (001) grains, has a thickness of 0.05 to 0.25 mm after two-stage cold rolling, and an angle (θ) satisfying 0°≤θ≤8°, the angle (θ) being formed between a rolling direction and a [100] crystal orientation exhibiting a maximum surface intensity in a (001) texture.

2. The electrical steel sheet of claim 1, wherein an average diameter of the (001) grains of the electrical steel sheet penetrates through a thickness of the electrical steel sheet and is 1 to 50 times larger than the thickness of the electrical steel sheet.

3. The electrical steel sheet of claim 2, wherein the average diameter of the (001) grains is in a range of from 0.3 to 5 mm.

4. The electrical steel sheet of claim 1, wherein an area fraction of the (001) grains is 80% or more.

5. The electrical steel sheet of claim 1, wherein the electrical steel sheet has a magnetic flux density (B₅₀) of 1.70 Tesla or more.

6. The electrical steel sheet of claim 5, wherein a ratio of steel sheet thickness to iron loss (W_{15/50}) thereof is in a range of 4 to 20 Watts/kg/mm.
